(19) United States
(12) Patent Application Publication
(10) Pub. No.: US 2021/0097391 A1
(43) Pub. Date: Apr. 1, 2021

(54) NETWORK MODEL COMPILER AND RELATED PRODUCT

(71) Applicant: Shenzhen Corerain Technologies Co., Ltd, Shenzhen (CN)

(72) Inventor: Ruizhe Zhao, Shenzhen (CN)

(73) Assignee: Shenzhen Corerain Technologies Co., Ltd., Shenzhen (CN)

(21) Appl. No.: 17/044,557

(22) PCT Filed: Apr. 17, 2018
(86) PCT No.: PCT/CN2018/083439

§ 371 Date: Oct. 1, 2020

(51) Int. Cl. G06N 3/08; G06N 3/04; G06F 8/41

(52) U.S. Cl. CPC G06N 3/08; G06F 8/41; G06N 3/04

(57) ABSTRACT

Disclosed are a network model compiler and a related product. The network model compiler includes a data IO unit, a compression unit and a storage unit. The data IO unit has one port connected to a data output port of a first computing platform and another port connected to a data input/output port of a second computing platform.

### TECHNICAL FIELD

The present application relates to the technical field of information processing, and particularly to a network model compiler and a related product.

### BACKGROUND

With the continuous development of information technologies and the increasing demand of people, the requirement of people on the timeliness of information becomes higher and higher. Network models such as neural network models have been more and more widely applied along with the development of technologies. The training and operation performed on the network model may be achieved for an apparatus such as a computer and a server; however, a trained network model may can be applied to the apparatus of this platform, for example, for the server, the trained network model may only be applied to a server platform; for a field-programmable gate array (FPGA) platform, which cannot apply the network model of the server platform, so that an existing network model compiler cannot achieve cross-platform of the network model and limit the application scene of the network model, which leads to high cost.

### SUMMARY

Embodiments of the present application provide a network model compiler and a related product, which can improve the application scene of a network model and reduce the cost. In a first aspect, a network model compiler is provided. The network model compiler includes a data IO unit, a compression unit and a storage unit. The data IO unit has one port connected to a data output port of a first computing platform and another port connected to a data input/output port of a second computing platform. The storage unit is configured to store a preset compression rule. The data IO unit is configured to receive a first weight data group of a trained network model sent by the first computing platform. The compression unit is configured to compress the first weight data group into a second weight data group according to the preset compression rule, where the second weight data group is a weight data group applied to the second computing platform. The data IO unit is further configured to send the second weight data group to the second computing platform.

In a second aspect, a method for transferring a network model is provided. The method includes: a first weight data group of a trained network model sent by the first computing platform is received; the first weight data group is compressed into a second weight data group according to a preset compression rule, where the second weight data group is a weight data group applied to the second computing platform; and the second weight data group is sent to the second computing platform.

In a third aspect, a computer-readable storage medium is provided. The computer-readable storage medium stores a computer program for electronic data exchange. The computer program causes a computer to perform the method described in the second aspect.

In a fourth aspect, a computer program product is provided. The computer program product includes a non-transitory computer-readable storage medium storing a computer program, and the computer program is executable to enable a computer to perform the method described in the second aspect.

According to the network model compiler in the technical scheme provided by the present application, after the weight data group of the network model of the first platform (such as a server) is received, the weight data group of the network model of the first platform is compressed to the weight data group of the second platform, and then the weight data group of the second platform is sent to the second computing platform (such as a FPGA), so that conversion between the two computing platforms is implemented, and thus the cross-platform application of the network model is achieved. Moreover, the compressed weight data group can significantly improve the optimization of the computational accuracy of the second computing platform, and for the second computing platform, the computation optimization on a computing node can be realized with the compressed weight data group, thereby achieving the purposes of saving computing resources and energy consumption.

### BRIEF DESCRIPTION OF DRAWINGS

In order to more clearly explain the technical schemes in embodiments of the present application, the drawings used for describing the embodiments will be briefly introduced below. Obviously, the drawings in the following description are some embodiments of the present application. For those of ordinary skill in the art, other drawings may also be obtained without creative labor according to these drawings.

FIG. 1 is a structural diagram of a network model compiler provided by an embodiment of the present application.

FIG. 2 is a schematic diagram of a method for transferring a network model provided by an embodiment of the present application.

### DETAILED DESCRIPTION

The technical schemes in embodiments of the present application will be described clearly and completely below in conjunction with the drawings in the embodiments of the present application. Apparently, the described embodiments are merely part of the embodiments of the present application, rather than all of the embodiments of the present application. All other embodiments obtained by those of ordinary skill in the art based on the embodiments of the present application without requiring creative efforts shall all fall within the scope of protection of the present application.

The terms “first”, “second”, “third”, “fourth, etc., in the description, claims and drawings of the present application are used for distinguishing different objects, rather than describing a particular order. Furthermore, the terms “include” and “have”, as well as any variations thereof, are intended to cover a non-exclusive inclusion. For example, a process, a method, a system, a product, or an apparatus that includes a series of steps or units is not limited to the given steps or units, but optionally further includes steps or units not given, or optionally further includes other steps or units inherent to such process, method, product, or apparatus.

Reference to “embodiment” herein means that a particular feature, structure, or characteristic described in conjunction with the embodiments may be included in at least one embodiment of the present application. The appearance of this word throughout the description does not necessarily all refer to the same embodiment, nor is it an independent or alternative embodiment mutually exclusive from other embodiments. Those skilled in the art understand, clearly and implicitly, that the embodiments described herein may be combined with other embodiments.

Since a mathematical method for simulating an actual neural network of a human comes out, people have been gradually habituated to directly refer to such artificial neural network as a neural network. The neural network has broad and attractive prospects in the fields of system identification, pattern recognition, intelligent control and the like. Especially in intelligent control, people are particularly interested in the self-learning function of the neural network, and this important characteristic of the neural network is regarded as one of keys for solving the problem of the adaptive capability of a controller in automatic control.

The neural network (NN) is a complex network system formed of a large number of simple processing units (referred to as neurons) which are widely connected to each other. The neural network reflects many basic features of the human brain function, and is a highly complex nonlinear power learning system. The neural network has capabilities of large-scale parallelism, distributed storage and processing, self-organization, self-adaptation, and self-learning, and is particularly suitable to deal with the problem of inaccurate and fuzzy information processing that requires simultaneous consideration of many factors and conditions. The development of the neural network is related to neuroscience, mathematical science, cognitive science, computer science, artificial intelligence, information science, control theory, robotics, microelectronics, psychology, optical computation, molecular biology and the like, and is an emerging marginal interdiscipline.

The neural network is based on neurons.

A neuron is a biological model based on a nerve cell of a biological nervous system. When people study the biological nervous system and discuss the mechanism of artificial intelligence, the neuron is represented mathematically, and thus a mathematical model of the neuron is generated.

A large number of neurons of the same form are joined together to form the neural network. The neural network is a highly nonlinear dynamics system. Although the structure and function of each neuron are not complex, the dynamic behavior of the neural network is very complex; therefore, various phenomena in the actual physical world may be expressed by using the neural network.

A neural network model is described based on the mathematical model of the neuron. The artificial neural network is a description of the first order characteristics of a human brain system. Briefly, the artificial neural network is a mathematical model. The neural network model is represented by a network topology, node characteristics and a learning rule. The huge attraction of the neural network to people mainly includes parallel and distributed processing, high robustness and fault-tolerant capability, distributed storage and learning capability, and the capability of fully approximating a complex nonlinear relationship.

Among the research topics of the control field, the problem of controlling an uncertain system has been one of the central themes of the control theory research for a long time, but this problem has never been well solved. The learning capability of the neural network enables the neural network to automatically learn the characteristics of the uncertain system in the process of controlling the system, so as to automatically adapt to the variation of the characteristics of the system along with time, and achieve the optimal control of the system; obviously, this is encouraging intention and method.

There are now dozens of models of the artificial neural network, among which BP neural network, Hopfield network, ART networks and Kohonen network are often used classical neural network models.

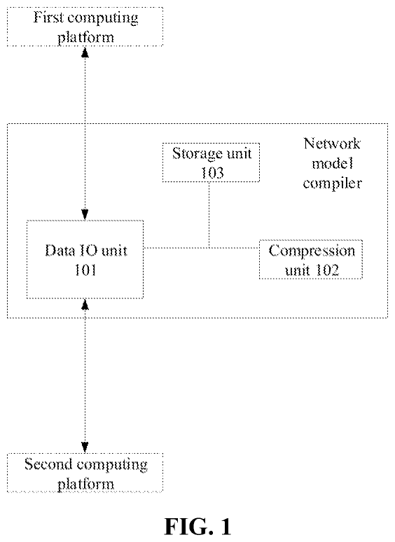

Reference is made to FIG. 1. FIG. 1 is a structural diagram of a network model compiler provided by this application. As shown in FIG. 1, the network model compiler includes a data IO unit 101, a compression unit 102, and a storage unit 103.

The data IO unit 101 has one port connected to a data output port of a first computing platform and another port connected to a data input/output port of a second computing platform.

The one port of the data IO unit 101 described above may specifically be a universal input/output port of the network model compiler, and of course, the another port may specifically be another universal input/output port of the network model compiler. Of course, the one port and the another port described above may also be in other forms, and a specific form of the ports described above is not limited in this application, and the ports described above are only needed to be able to receive and send data.

The storage unit 103 is configured to store a preset compression rule; of course, in practical applications, the compression unit described above may also store data such as a weight data group, scalar data, a computing instruction.

The data IO unit 101 is configured to send a first weight data group of the trained network model after completing a training of the network model by the first computing platform.

The compression unit 102 is configured to compress the first weight data group into a second weight data group according to the preset compression rule, where the second weight data group is a weight data group applied to the second computing platform;

The data IO unit 101 is configured to send the second weight data group to the second computing platform.

According to the network model compiler in the technical scheme provided by the present application, after the weight data group of the network model of the first platform (such as a server) is received, the weight data group of the network model of the first platform is compressed to the weight data group of the second platform, and then the weight data group of the second platform is sent to the second computing platform (such as a FPGA), so that conversion between the two computing platforms is implemented, and thus the cross-platform application of the network model is achieved. Moreover, the compressed weight data group can significantly improve the optimization of the computational accuracy of the second computing platform, and for the second computing platform, the compressed weight data group can perform the computation optimization on a computing node, thereby achieving the purposes of saving computing resources and energy consumption.

A detailed scheme of the above technical scheme is introduced below. For the neural network model, it is divided into two large parts, namely a training and a forward operation. For the training, it is a process of optimizing the neural network model. The specific implementation manner may include described below. A large number of labeled samples (generally 50 or more samples) are sequentially input into an original neural network model (a weight data group at this time has an initial numerical value) to perform iterative operation for multiple times to update an initial weight. Each time of iterative operation includes an n-layer forward operation and an n-layer reverse operation. The weight of the n-layer reverse operation is used for gradient updating of the weight of a corresponding layer, the updating of the weight data group for multiple times may be achieved through computation of multiple samples to complete the training of the neural network model. The trained neural network model receives data to be computed, and the n-layer forward operation is performed on the data to be computed and the trained weight data group to obtain an output result of the forward operation, as such, the output result is analyzed to obtain an operation result of the neural network, and if this neural network model is a neural network model for face recognition, then the operation result thereof is regarded to be matched or mismatched.

For the training of the neural network model, a large amount of computation is needed, since for the n-layer forward operation and the n-layer reverse operation, an amount of computation of any layer relates to a large amount of computation. The neural network model for face recognition is taken as an example, operations at each layer are mostly convolution operations, and input data of convolution has thousands of rows and thousands of columns, then the number of product operations of one convolution operation of such large data can reach 10⁶ times, thus the requirement for a processor is high, a large amount of expenditure needs to be consumed to perform such operation, not to mention that such operation needs to be subjected to multiple iterations and n layers, and each sample needs to be computed once, thereby the computational overhead is further increased. This computational overhead cannot be achieved through a FPGA at present. Excessive computational overhead and power consumption require high hardware configuration. The cost of such hardware configuration is obviously unrealistic for a FPGA device. In order to solve this technical problem, two ideas are provided. A first idea is a centralized processing idea, that is, the FPGA device does not perform operations of the neural network, but sends the operations of the neural network to a background server for processing. The defect of this manner is that the timeliness is not enough, because the massive FPGA devices have an extremely high requirement on the number of background server configurations. Taking a camera of a monitoring system familiar to people at present as an example, there may be more than a thousand cameras in one building, and thus the background server cannot perform the operations quickly when it is busy. A second idea is to perform the operation of the neural network on the FPGA device itself, however in this manner, adaptive weight data group are needed to be configured for the neural network model of the FPGA device.

For different computing platforms, since hardware configurations are different, weight data groups obtained through the training are also different. For example, operation capability of the server can be very high, so that the accuracy of the weight data groups is high, the accuracy of the operation result is also high when the computation of the neural network model is performed. But for the FPGA device, its hardware configuration is low, the computing power is weak, and the capability of processing the weight data group is also weak. It is certainly inappropriate to directly configure the weight data group of the server into the FPGA device, it inevitably causes the computation delay of the FPGA device to be greatly increased, and even the situation that the FPGA device cannot be operated occurs. In order to adapt to the application of the FPGA device, hereinafter, the weight data group of the server is compressed to obtain another weight data group, since the another compressed weight data group after compression is much smaller than the weight data group before compression, so that although the accuracy is affected to a certain extent, the FPGA device is applicable.

Optionally, the compression unit 102 is specifically configured to convert a format of the first weight data group from a floating point data format into a fixed point data format to obtain the second weight data group. The second weight data group is a weight data group applied to the second computing platform.

At present, the floating point data has 32 bits in the server and a computer apparatus, thousands of data may exist in one weight data group, a total number of bits may exceed 10⁷ bits (here because there are n layers, and each layer has one weight data); the fixed point data has 16 bits. Although the accuracy of the fixed point data is reduced to a certain extent relative to the floating point data, a data volume of the fixed point data is reduced by a half compared with the floating point data, firstly, the storage space and calling overhead of the fixed point data are greatly reduced, and in addition, the computational overhead of the fixed point data is greatly reduced because of less bits of the fixed point data, and in this way, the cross-platform application can be achieved.

Optionally, the compression unit 102 is specifically configured to set elements with element values less than a set threshold value in the first weight data group to zero for sparsification to obtain the second weight data group.

The above technical scheme is mainly directed to sparsification of the weight data group. For the first weight data group, if an element value of an element in the first weight data group is very small, namely, less than the set threshold value, then the result obtained from the computation of the element also has a slight influence on a final computation result, and thus the computation of this element is directly ignored after the sparsification of the weight data group. In this way, the operation for a zero element is not needed, so that the computational overhead is reduced; in addition, the zero element may not be stored in the storage unit, and only a position of the zero element in the weight data group may be stored.

Optionally, the compression unit 102 is specifically configured to convert a format of the first weight data group from a floating point data format into a weight data group of a fixed point data format, and set elements with element values less than a set threshold value in the weight data group of the fixed point data format to zero to obtain the second weight data group.

According to the above scheme, the data format conversion and the sparsification are combined, so that the computational overhead and corresponding configuration can be further reduced.

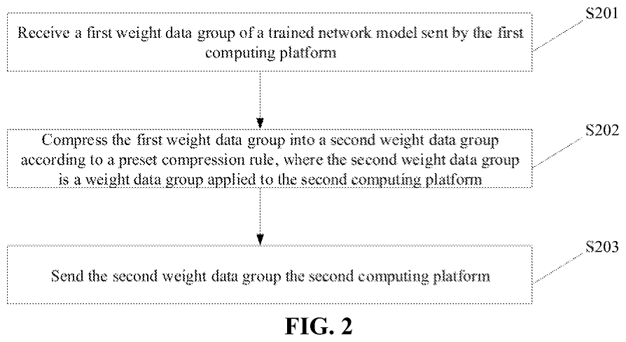

Reference is made to FIG. 2. FIG. 2 is a method for transferring a network model provided by the present application. The method includes steps described below.

In S201, a first weight data group of a trained network model sent by the first computing platform is received.

In S202, the first weight data group is compressed into a second weight data group according to a preset compression rule, where the second weight data group is a weight data group applied to the second computing platform.

In S203, the second weight data group is sent to the second computing platform.

According to the method in the technical scheme provided by the present application, after the weight data group of the network model of the first platform (such as a server) is received, the weight data group of the network model of the first platform is compressed to the weight data group of the second platform, and then the weight data group of the second platform is sent to the second computing platform (such as a FPGA), so that conversion between the two computing platforms is implemented, and thus the cross-platform application of the network model is achieved.

For the neural network model, it is divided into two large parts, namely a training and a forward operation. For the training, it is a process of optimizing the neural network model. The specific implementation manner may include described below. A large number of labeled samples (generally 50 or more samples) are sequentially input into an original neural network model (a weight data group at this time is an initial numerical value) to perform iterative operation for multiple times to update an initial weight. Each time of iterative operation includes an n-layer forward operation and an n-layer reverse operation. The weight of the n-layer reverse operation is used for gradient updating of the weight of a corresponding layer, the updating of the weight data group for multiple times may be achieved through computation of multiple samples to complete the training of the neural network model. The trained neural network model receives data to be computed, and the n-layer forward operation is performed on the data to be computed and the trained weight data group to obtain an output result of the forward operation, as such, the output result is analyzed to obtain an operation result of the neural network, and if this neural network model is a neural network model for face recognition, then the operation result thereof is regarded to be matched or mismatched.

For the training of the neural network model, a large amount of computation is needed, since for the n-layer forward operation and the n-layer reverse operation, an amount of computation of any layer relates to a large amount of computation. The neural network model for face recognition is taken as an example, operations at each layer are mostly convolution operations, and input data of convolution are thousands of rows and thousands of columns, then the number of product operations of one convolution operation of such large data can reach 10⁶ times, thus the requirement for a processor is high, a large amount of expenditure needs to be consumed to perform such operation, not to mention that such operation needs to be subjected to multiple iterations and n layers, and each sample needs to be computed once, thereby the computational overhead is further increased. This computational overhead cannot be achieved through a FPGA at present. Excessive computational overhead and power consumption require high hardware configuration. The cost of such hardware configuration is obviously unrealistic for a FPGA device. In order to solve this technical problem, two ideas are provided. A first idea is a centralized processing idea, that is, the FPGA device does not perform operations of the neural network, but sends the operations of the neural network to a background server for processing. The defect of this manner is that the timeliness is not enough, because the massive FPGA devices have an extremely high requirement on the number of background server configurations. Taking a camera of a monitoring system familiar to people at present as an example, there may be more than a thousand cameras in one building, and thus the background server cannot perform the operation quickly when it is busy. A second idea is to perform the operation of the neural network on the FPGA device itself, however in this manner, an adaptive weight data group are needed to be configured for the neural network model of the FPGA device.

For different computing platforms, since hardware configurations are different, weight data groups obtained through the training are also different. For example, operation capability of the server can be very high, so that the accuracy of the weight data groups is high, the accuracy of the operation result is also high when the computation of the neural network model is performed. But for the FPGA device, its hardware configuration is low, the computing power is weak, and the capability of processing the weight data group is also weak. It is certainly inappropriate to directly configure the weight data group of the server into the FPGA device, it inevitably causes the computation delay of the FPGA device to be greatly increased, and even the situation that the FPGA device cannot be operated occurs. In order to adapt to the application of the FPGA device, hereinafter, the weight data group of the server is compressed to obtain another weight data group, since the another compressed weight data group after compression is much smaller than the weight data group before compression, so that although the accuracy is affected to a certain extent, the FPGA device is applicable.

Optionally, the step in which the first weight data group is compressed into the second weight data group according to the preset compression rule specifically includes: a format of the first weight data group is converted from a floating point data format into a fixed point data format to obtain the second weight data group.

At present, the floating point data has 32 bits in the server and a computer apparatus, thousands of data may exist in one weight data group, a total number of bits may exceed 10⁷ bits (here because there are n layers, an each layer has one weight data); the fixed point data has 16 bits. Although the accuracy of the fixed point data is reduced to a certain extent relative to the floating point data, a data volume of the fixed point data is reduced by a half compared with the floating point data, firstly, the storage space and calling overhead of the fixed point data are greatly reduced, and in addition, the computational overhead of the fixed point data is greatly reduced because of less bits of the fixed point data, and in this way, the cross-platform application can be achieved.

Optionally, the step in which the first weight data group is compressed into the second weight data group according to the preset compression rule specifically includes: elements with element values less than a set threshold value in the first weight data group are set to zero for sparsification to obtain the second weight data group.

The above technical scheme is mainly directed to sparsification of the weight data group. For the first weight data group, if an element value of an element in the first weight data group is very small, namely, less than the set threshold value, then the result obtained from the computation of the element also has a slight influence on a final computation result, and thus the computation of this element is directly ignored after the sparsification of the weight data group. In this way, the operation for a zero element is not needed, so that the computational overhead is reduced; in addition, the zero element may not be stored in the storage unit, and only a position of the zero element in the weight data group may be stored.

Optionally, the step in which the first weight data group is compressed into the second weight data group according to the preset compression rule specifically includes: a format of the first weight data group is converted from a floating point data format into a weight data group of a fixed point data format, and elements with element values less than a set threshold value in the weight data group of the fixed point data format are set to zero to obtain the second weight data group.

The present application further provides a computer-readable storage medium. The computer-readable storage medium stores a computer program for electronic data exchange. The computer program enables a computer to perform the method as shown in FIG. 2 and a detailed scheme of this method.

The present application further provides a computer program product. The computer program product includes a non-transitory computer-readable storage medium storing a computer program. The computer program is operable to enable a computer to perform as shown in FIG. 2 and a detailed scheme of this method.

It should be noted that for the foregoing method embodiments, for the sake of simple description, they are all expressed as a series of action combinations, but those skilled in the art should know that the present application is not limited by the described sequence of actions, since certain steps may be performed in other orders or concurrently in accordance with the present application.

Secondly, those skilled in the art should also know that the embodiments described in the description are all optional embodiments, and that the actions and modules involved are not necessarily required by the present application.

In the embodiments described above, the description of various embodiments has emphasis on each. For parts that are not described in detail in certain embodiment, reference may be made to related descriptions of other embodiments.

In several embodiments provided in this application, it should be understood that the disclosed device may be implemented in other ways. For example, the device embodiments described above are merely illustrative, for example, the division of said unit is only a logical function division, and there may be additional ways of division in actual implementation, for example multiple units or assemblies may be combined or integrated into another system, or some features may be ignored, or not performed. In addition, the displayed or discussed mutual coupling or direct coupling or communication connection may be an indirect coupling or a communication connection through some interfaces, devices or units, and may be in electrical or other forms.

The units described as separate components may or may not be physically separated, and the components displayed as the unit may or may not be physical units, i.e., they may be located in one place or distributed across multiple network units. Part or all of the units may be selected according to practical requirements to achieve the purpose of the scheme of this embodiment.

In addition, each functional unit in each embodiment of the present application may be integrated into one processing unit, or each unit may exist independently and physically, or two or more units may be integrated into one unit. The integrated unit described above may be achieved in the form of hardware or a software program module.

The integrated unit described above, if implemented in the form of a software program module and sold or used as a separate product, may be stored in a computer-readable memory. Based on such understanding, the technical scheme of the present application, either essentially or in terms of contributions to the related art, or all or part of the technical schemes, may be embodied in the form of a software product, and the computer software product is stored in a memory, the memory includes several instructions for enabling a computer apparatus (which may be a personal computer, a server, or a network apparatus, etc.) to perform all or part of the steps of the methods described in the various embodiments of the present application. However, the aforementioned memory includes various media capable of storing program codes, such as a USB flash disk, a read-only memory (ROM), a random access memory (RAM), a mobile hard disk, a magnetic disk or an optical disk.

It should be understood by those of ordinary skill in the art that all or part of the steps in the various methods of the above embodiments may be implemented by a program, which is stored in a computer-readable memory, the memory includes a flash memory disk, a read-only memory (referred to as ROM), a random access memory (referred to as RAM), a magnetic disk or an optical disk.

The embodiments of the present application are described in detail above, and specific examples are used herein to illustrate the principles and implementations of the present application. The description of the above embodiments is merely intended to help understand the method and core ideas of the present application; meanwhile, for a person skilled in the art, according to the idea of the present application, the specific implementation manner and the application scope may be changed, and in summary, the content of the present Description should not be construed as a limitation to the present application.

1. A network model compiler, comprising a data IO unit, a compression unit and a storage unit, wherein the data IO unit has one port connected to a data output port of a first computing platform and another port connected to a data input/output port of a second computing platform;
the storage unit is configured to store a preset compression rule;
the data IO unit is configured to receive a first weight data group of a trained network model sent by the first computing platform;
the compression unit is configured to compress the first weight data group into a second weight data group according to the preset compression rule, wherein the second weight data group is a weight data group applied to the second computing platform; and
the data IO unit is further configured to send the second weight data group to the second computing platform.

2. The network model compiler of claim 1, wherein,
the compression unit is specifically configured to convert a format of the first weight data group from a floating point data format into a fixed point data format to obtain the second weight data group.

3. The network model compiler of claim 1, wherein,
the compression unit is specifically configured to set elements with element values less than a set threshold value in the first weight data group to zero for sparsification to obtain the second weight data group.

4. The network model compiler of claim 1, wherein,
the compression unit is specifically configured to convert a format of the first weight data group from a floating point data format into a weight data group of a fixed point data format, and set elements with element values less than a set threshold value in the weight data group of the fixed point data format to zero to obtain the second weight data group.

5. A method for transferring a network model, comprising:
receiving a first weight data group of a trained network model sent by the first computing platform;
compressing the first weight data group into a second weight data group according to a preset compression rule, wherein the second weight data group is a weight data group applied to the second computing platform; and
sending the second weight data group to the second computing platform.

6. The method of claim 5, wherein compressing the first weight data group into the second weight data group according to the preset compression rule specifically comprises:
converting a format of the first weight data group from a floating point data format into a fixed point data format to obtain the second weight data group.

7. The method of claim 5, wherein compressing the first weight data group into the second weight data group according to the preset compression rule specifically comprises:
setting elements with element values less than a set threshold value in the first weight data group to zero for sparsification to obtain the second weight data group.

8. The method of claim 5, wherein compressing the first weight data group into the second weight data group according to the preset compression rule specifically comprises:
converting a format of the first weight data group from a floating point data format into a weight data group of a fixed point data format, and set elements with element values less than a set threshold value in the weight data group of the fixed point data format to zero to obtain the second weight data group.

9. A computer-readable storage medium, storing a computer program for electronic data exchange, wherein the computer program causes a computer to perform a method for transferring a network model,
wherein the method comprises:
receiving a first weight data group of a trained network model sent by the first computing platform;
compressing the first weight data group into a second weight data group according to a preset compression rule, wherein the second weight data group is a weight data group applied to the second computing platform; and
sending the second weight data group to the second computing platform.

10. A computer program product, wherein the computer program product comprises a non-transitory computer-readable storage medium storing a computer program, and the computer program is executable to cause a computer to perform the method of claim 5.
